(19) United States
(12) Patent Application Publication
(10) Pub. No.: US 2026/0104265 A1
(43) Pub. Date: Apr. 16, 2026

(54) ROUTE GUIDING DEVICE, ROUTE GUIDING METHOD, AND STRADDLE TYPE VEHICLE

(71) Applicant: HONDA MOTOR CO., LTD., Tokyo (JP)

(72) Inventors: Mitsuru KOWADA, Tokyo (JP); Hodaka MUKOHARA, Tokyo (JP)

(73) Assignee: HONDA MOTOR CO., LTD., Tokyo (JP)

(21) Appl. No.: 19/395,168

(22) Filed: Nov. 20, 2025

Related U.S. Application Data
(63) Continuation of application No. PCT/JP2024/018054, filed on May 15, 2024.

(30) Foreign Application Priority Data
May 23, 2023 (JP) 2023-084682

(51) Int. Cl. G01C 21/36; B62J 45/41; B62J 50/22; H04N 7/18

(52) U.S. Cl. CPC G01C 21/3647; B62J 45/41; B62J 50/22; G01C 21/3632; H04N 7/183

(57) ABSTRACT

When guiding a course change of a vehicle before reaching a course change point, a direction indication image for the course change and a peripheral image side by side is displayed. A region in which subjects on a destination side of the course change is extracted from the peripheral image according to a distance between the course change point and the vehicle. When there is a peripheral object approaching within a predetermined distance, a warning is displayed by superimposing at a position corresponding to the object on the peripheral image, and the region to be extracted from the peripheral image is set to a region closer to the vehicle when the distance between the course change point and the vehicle falls below a threshold than when the distance exceeds the threshold.

### CROSS-REFERENCE TO RELATED APPLICATION(S)

This application is a continuation of International Patent Application No. PCT/JP2024/018054 filed on May 15, 2024, which claims priority to and the benefit of Japanese Patent Application No. 2023-084682 filed on May 23, 2023, the entire disclosures of which are incorporated herein by reference.

### BACKGROUND OF THE INVENTION

### Field of the Invention

The present invention relates to a vehicle route guiding technology.

### Description of the Related Art

There is a vehicle that holds a portable information terminal at a position of a meter panel and displays an engine speed and map information by using a display device of the portable information terminal (Patent Literature 1).

### CITATION LIST

### Patent Literature

PTL 1: Japanese Patent Laid-Open No. 2013-184547

### Technical Problem

As one aspect of information presentation using map information, there is route guidance. In the route guidance, when a vehicle approaches a point where a right or left turn or a lane change is required, information is displayed to guide a driver in a direction in which the vehicle is to change its course. Normally, the driver needs to check a rear side with a rearview mirror or visual observation at the time of a course change. However, in a case where information of the route guidance is presented using the display device as in Patent Literature 1, the number of places to which the driver is to direct their gaze within a limited time until the course change increases, which may give the driver a sense of complexity.

### SUMMARY OF THE INVENTION

An object of the present invention is to assist a driver in checking a rear side at the time of course changes, and thus contribute to improvement of safety in vehicle driving.

The present invention in its first aspect provides a route guidance device which provides route guidance based on route guidance information, comprising: an image acquisition unit configured to acquire a peripheral image of a vehicle including at least a rear side of the vehicle; and a display control unit configured to display, when guiding a course change of the vehicle before the vehicle reaches a course change point, a direction indication image for the course change and the peripheral image side by side on a display, wherein the display control unit changes arrangement of the direction indication image and the peripheral image according to a direction of the course change, and the peripheral image is arranged on a destination side of the course change on the display, wherein the route guiding device further comprises a deriving unit configured to derive, based on the peripheral image, a distance between the vehicle and peripheral objects of the vehicle, wherein the display control unit extracts, from the peripheral image, a region in which subjects on a destination side of the course change according to a distance between the course change point and the vehicle, and displays the region on the display, in a case where there is a peripheral object approaching within a predetermined distance, the display control unit displays a warning on the display by superimposing the warning at a position corresponding to the peripheral object on the peripheral image, and the region to be extracted from the peripheral image is set to a region closer to the vehicle in a case where the distance between the course change point and the vehicle falls below a threshold than in a case where the distance exceeds the threshold.

The present invention in its second aspect provides a route guidance method performed by a route guiding device which provides route guidance based on route guidance information, comprising: an image acquisition step of acquiring a peripheral image of a vehicle including at least a rear side of the vehicle; and a display control step of displaying, when guiding a course change of the vehicle before the vehicle reaches a course change point, a direction indication image for the course change and the peripheral image side by side on a display, wherein in the display control step, arrangement of the direction indication image and the peripheral image is changed according to a direction of the course change, and the peripheral image is arranged on a destination side of the course change on the display, wherein the route guiding method further comprises a deriving step of deriving based on the peripheral image, a distance between the vehicle and peripheral objects of the vehicle, wherein in the display control step: a region in which subjects on a destination side of the course change is extracted from the peripheral image according to a distance between the course change point and the vehicle, and is displayed on the display, and in a case where there is a peripheral object approaching within a predetermined distance, a warning is displayed on the display by superimposing the warning at a position corresponding to the peripheral object on the peripheral image, and the region to be extracted from the peripheral image is set to a region closer to the vehicle in a case where the distance between the course change point and the vehicle falls below a threshold than in a case where the distance exceeds the threshold.

The present invention in its third aspect provides a straddle type vehicle comprising a display a camera and a control device and providing route guidance based on route guidance information, wherein the control device includes an image acquisition unit configured to acquire a peripheral image of the straddle type vehicle, including at least a rear side of the straddle type vehicle, captured by the camera, and a display control unit configured to display, when guiding a course change of the straddle type vehicle before the straddle type vehicle reaches a course change point, a direction indication image for the course change and the peripheral image side by side on the display, wherein the display control unit changes arrangement of the direction indication image and the peripheral image according to a direction of the course change, and the peripheral image is arranged on a destination side of the course change on the display, wherein the control device further comprises a deriving unit configured to derive, based on the peripheral image, a distance between the straddle type vehicle and peripheral objects of the straddle type vehicle, wherein the display control unit extracts, from the peripheral image, a region in which subjects on a destination side of the course change according to a distance between the course change point and the straddle type vehicle, and displays the region on the display, in a case where there is a peripheral object approaching within a predetermined distance, the display control unit displays a warning on the display by superimposing the warning at a position corresponding to the peripheral object on the peripheral image, and the region to be extracted from the peripheral image is set to a region closer to the straddle type vehicle in a case where the distance between the course change point and the straddle type vehicle falls below a threshold than in a case where the distance exceeds the threshold.

Further features of the present invention will become apparent from the following description of exemplary embodiments (with reference to the attached drawings).

### Advantageous Effects of Invention

According to the present invention, it is possible to assist the driver in checking the rear side at the time of course changes, and thus contribute to improvement of safety in vehicle driving.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram of a route guiding system 1.

FIG. 2A is a block diagram illustrating a configuration of a portable communication terminal 3.

FIG. 2B is a block diagram illustrating a configuration of a route planning server 5.

FIG. 3A is a block diagram illustrating a configuration of an in-vehicle device 40 according to a first embodiment.

FIG. 3B is a block diagram illustrating a configuration of the in-vehicle device 40 according to a third embodiment.

FIG. 4A is a view illustrating a guidance screen for guiding a leftward course change.

FIG. 4B is a view illustrating a guidance screen for guiding a rightward course change.

FIG. 5A is a diagram illustrating an image captured by an in-vehicle camera 44.

FIG. 5B is a diagram illustrating an example of a rear image extracted at the time of advance notice of the leftward course change.

FIG. 5C is a diagram illustrating an example of a rear image extracted at the time of advance notice of the rightward course change.

FIG. 6A is a diagram illustrating a guidance screen for guiding the leftward course change in a case where a distance to a course change point falls below a threshold.

FIG. 6B is a diagram illustrating a guidance screen for guiding the rightward course change in a case where a distance to a course change point falls below the threshold.

FIG. 7 is a flowchart illustrating display control processing executed by the portable communication terminal 3 of the first embodiment.

FIG. 8A is a diagram illustrating a mode of directly receiving a captured image from a roadside camera 7 according to a third modification.

FIG. 8B is a diagram illustrating a mode of receiving the captured image of the roadside camera 7 from an external device 8 according to the third modification.

FIG. 9A is a diagram illustrating a guidance screen for guiding the rightward course change with a warning in a case where the distance to the course change point exceeds the threshold according to a first modification.

FIG. 9B is a diagram illustrating a guidance screen for guiding the rightward course change with a warning in a case where the distance to the course change point falls below the threshold according to the first modification.

### DESCRIPTION OF THE EMBODIMENTS

### First Embodiment

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

An embodiment to be described below will describe an example in which the present invention is applied to a portable communication terminal, which is mounted on a straddle type vehicle on which a driver rides and presents information regarding route guidance to a destination, as an example of a route guiding device. However, the present invention is applicable to any device capable of presenting the information regarding route guidance.

### Outline of System

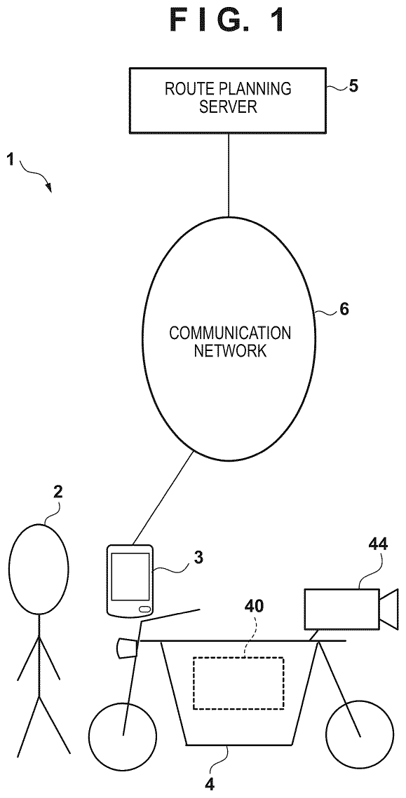

FIG. 1 is a schematic diagram of a route guiding system 1. The route guiding system 1 is a system which provides a route guiding service in which a portable communication terminal 3 provides route guidance to a driver 2 operating a straddle type vehicle 4 according to information on a route to a destination planned by a route planning server 5 (hereinafter, referred to as route guidance information). The route planning server 5 is a server which is connected in a communication-enabling manner to the portable communication terminal 3 via a communication network 6 and generates route guidance information regarding a route from a departure point to a destination input in each portable communication terminal 3.

In an example of FIG. 1, each driver 2 is a driver of the straddle type vehicle 4. In addition, the portable communication terminal 3 is a portable terminal such as a smartphone used by the driver 2. The portable communication terminal 3 includes a display device, a wireless communication device, and an input device, and functions as a client capable of transmitting and receiving information to and from the route planning server 5 or the like. Each straddle type vehicle 4 is mounted with an in-vehicle device 40 which entirely controls the operation of the vehicle. The in-vehicle device 40 includes a wireless communication device capable of communicating with the portable communication terminal 3, an ECU which controls a drive system of the straddle type vehicle 4, or the like. In the present embodiment, when the route guiding service is used in the portable communication terminal 3, the portable communication terminal 3 and the in-vehicle device 40 are connected in a communication-enabling manner.

An application for providing the route guiding service is installed in the portable communication terminal 3, and the portable communication terminal 3 can function as a route guiding device which provides route guidance from a departure point to a destination according to the route guidance information provided from the route planning server 5.

In the present embodiment, a description is given assuming that the vehicle driven by the driver 2 is a straddle type vehicle (motorcycle). However, the present invention is not limited to the case of driving the straddle type vehicle, and can be used, for example, in the case of driving any mobile vehicle, such as a passenger car or a freight car, operated by the driver 2 other than the straddle type vehicle.

### Configuration Example of Portable Communication Terminal 3

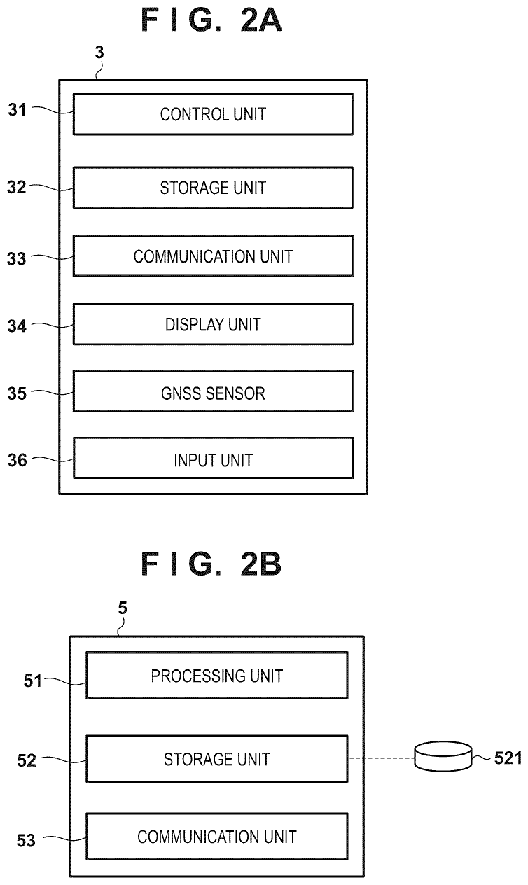

FIG. 2A is a block diagram of the portable communication terminal 3. The portable communication terminal 3 includes a control unit 31, a storage unit 32, a communication unit 33, a display unit 34, a global navigation satellite system (GNSS) sensor 35, and an input unit 36. The control unit 31 is a processor represented by a CPU, and executes a program stored in the storage unit 32. The storage unit 32 is a storage device such as a RAM or a ROM. The program stored in the storage unit 32 also includes an application (hereinafter, may be referred to as a route guidance application) program for using the route guiding service of the present embodiment. The application program may be downloaded from a server such as the route planning server 5 or an application distribution server, or may be distributed in a storage medium such as a CD-ROM.

The communication unit 33 is a wireless communication device capable of communicating with the route planning server 5 via the communication network 6. In addition, the communication unit 33 includes a wireless communication device capable of directly communicating with the in-vehicle device 40. The display unit 34 is an electronic image display device (display) having an input function, and is, for example, a touch panel display. The GNSS sensor 35 is a sensor which detects the current position of the portable communication terminal 3. The input unit 36 is various user interfaces which receive operation inputs included in the portable communication terminal 3. The various user interfaces include an operation member provided in the portable communication terminal 3 such as a switch, and a sensor for detecting a touch input to the display unit 34.

### Configuration Example of In-Vehicle Device 40

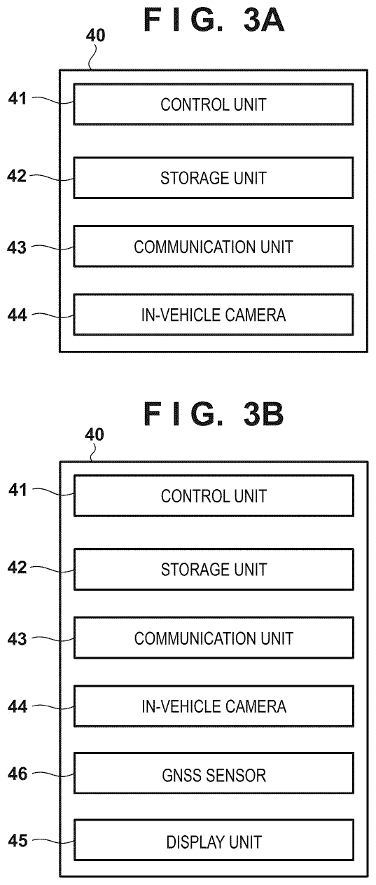

FIG. 3A is a block diagram of the in-vehicle device 40 according to the present embodiment. The in-vehicle device 40 includes a control unit 41, a storage unit 42, a communication unit 43, and an in-vehicle camera 44. The control unit 41 is a processor represented by a CPU, and executes a program stored in the storage unit 42. The storage unit 42 is a storage device such as a RAM and a ROM. The program stored in the storage unit 42 includes a program for performing information communication with the portable communication terminal 3. The communication unit 43 is a wireless communication device capable of directly communicating with the portable communication terminal 3.

The in-vehicle camera 44 is a camera including an optical system such as a lens and an imaging sensor, and is capable of capturing an image. The in-vehicle camera 44 may be configured to be incorporated in advance into the straddle type vehicle 4, or may be mounted afterward to the outside of the straddle type vehicle 4. In the present embodiment, it is assumed that the in-vehicle camera 44 is installed so as to capture the rear side of the straddle type vehicle 4.

### Configuration Example of Route Planning Server 5

FIG. 2B is a block diagram of the route planning server 5. The route planning server 5 includes a control unit 51, a storage unit 52, and a communication unit 53. The control unit 51 is a processor represented by a CPU, and executes a program stored in the storage unit 52. The storage unit 52 is a storage device such as a RAM, a ROM, and a hard disk. The communication unit 53 is a wired or wireless communication device capable of communicating with the portable communication terminal 3 via the communication network 6.

The storage unit 52 stores various types of data in addition to the program executed by the control unit 51. In an example of FIG. 2B, as data to be stored in the storage unit 52, a database (DB) 521 is given as an example. The DB 521 is a DB (hereinafter, referred to as a road DB) in which information on a road through which the straddle type vehicle 4 can pass is registered. The information (road information) accumulated in the road DB 521 includes, in addition to information such as a position, an address, a gradient, and a surrounding landmark of each road, information such as a traffic rule to be observed for each road and a traffic situation (a traffic congestion situation and an accident occurrence situation) acquired in real time.

When receiving at least information on a departure point and a destination together with a route guidance request from the portable communication terminal 3, the control unit 51 plans a route from the departure point to the destination on the basis of the road information managed by the road DB 521, generates route guidance information, and returns the route guidance information to the portable communication terminal 3. Here, the information on the departure point and the destination is input by the driver 2 in the portable communication terminal 3. Alternatively, for example, in a case where the vehicle deviates from a planned route or a case where a start request for guidance from a current location is made, information on the current location of the portable communication terminal 3 acquired by the GNSS sensor 35 can be used as the information on the departure point without input by the driver 2. When receiving route guidance information from the route planning server 5 during the execution of the route guidance application, the control unit 31 of the portable communication terminal 3 provides route guidance to the driver 2 by using the route guidance information. The route guidance is provided by using information display on the display unit 34. The display related to the route guidance includes a display in which information on the route designated by the route guidance information, the current location of the straddle type vehicle 4, and a direction in which the straddle type vehicle 4 is directed are superimposed on map information around the current location of the portable communication terminal 3 (straddle type vehicle 4). The display related to the route guidance includes, in addition to this, a guidance display for course changes presented in a case where the straddle type vehicle 4 is present at an intersection where a right or left turn is required, or at a location where it is necessary to be in a specific lane. Hereinafter, a point requiring such course change guidance will be referred to as a “course change point”.

### Course Change Guidance Display

Hereinafter, the guidance display for course changes will be described in detail with reference to the drawings.

When the straddle type vehicle 4 approaches the course change point defined in the route guidance information, the control unit 31 determines to provide course change guidance. The approach to the course change point may be performed, for example, on condition that a distance between the course change point and the straddle type vehicle 4 falls below a predetermined distance threshold. The guidance of the course change is performed in multiple stages, such as giving advance notice that a course change is required ahead to prompt the driver to prepare an operation related to the course change, or notifying a timing at which the course change actually becomes necessary.

As described above, for the course change, it is necessary for the driver 2 to check the rear side, but it is troublesome for the driver 2 to visually check the rear side each time particularly in a situation where the notification is performed in multiple stages. Therefore, in the route guidance application of the present embodiment, at the timing of guiding the course change, a screen in which a direction indication image indicating a course change direction and an image (rear image) indicating a situation behind the straddle type vehicle 4 captured by the in-vehicle camera 44 are arranged side by side is displayed. Here, the direction indication image may be an image presented in a so-called turn-by-turn display.

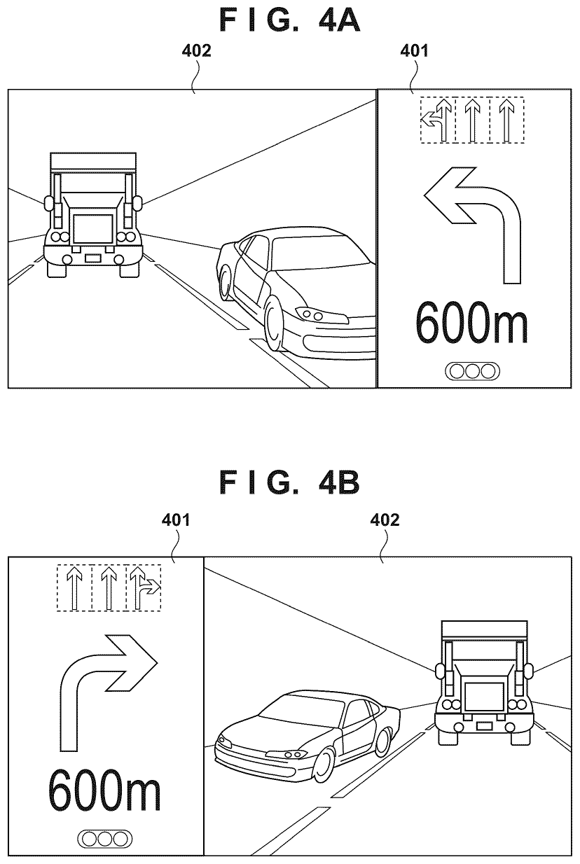

The screen displayed on the display unit 34 can be configured as illustrated in FIGS. 4A and 4B, for example. FIG. 4A illustrates a screen displayed in a case where a leftward course change is guided, and FIG. 4B illustrates a screen displayed in a scene where a rightward course change is guided. As illustrated in the drawing, in the route guidance application of the present embodiment, the screen presented at the time of course change guidance (hereinafter, referred to as a guidance screen) is configured such that a direction indication image 401 and a rear image 402 are arranged side by side in a horizontal direction so that the driver 2 can check both at the same time. Therefore, the control unit 31 transmits a request for providing the captured image of the in-vehicle camera 44 to the straddle type vehicle 4 via the communication unit 33 at the time of the course change guidance, and acquires the image.

As illustrated, the arrangement of the direction indication image 401 and the rear image 402 on the guidance screen differs depending on the direction of the course change. More specifically, the rear image 402 is arranged on a course change destination side on the guidance screen, that is, a side to which the straddle type vehicle 4 travels as viewed from the driver 2. Therefore, on the guidance screen for guiding the leftward course change in FIG. 4A, the rear image 402 is arranged on the left side, and the direction indication image 401 is arranged on the right side. In addition, on the guidance screen for guiding the rightward course change in FIG. 4B, the rear image 402 is arranged on the right side, and the direction indication image 401 is arranged on the left side. In this way, the driver can intuitively and easily check, via the guidance screen, the presence or absence of a vehicle traveling behind on the course change destination side, an inter-vehicle distance, or the like.

### Extraction of Rear Image

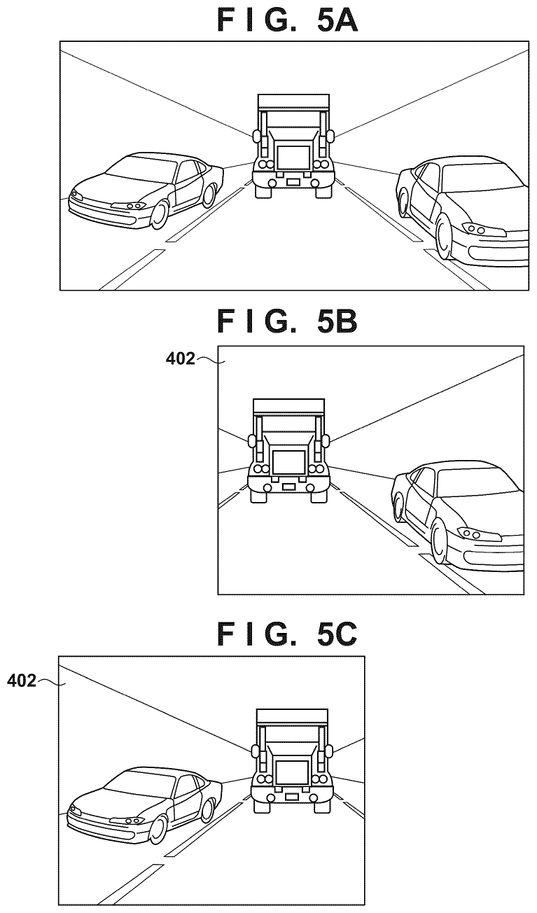

Here, the rear image 402 arranged on the guidance screen is generated by extracting an image of a partial region of the image captured by the in-vehicle camera 44. In a mode in which one in-vehicle camera 44 is mounted on the straddle type vehicle 4 as illustrated in the present embodiment, as illustrated in FIG. 5A, the image obtained by capturing the rear side has the direct rear of the straddle type vehicle 4 as the center of the angle of view. Therefore, since both subjects on the left rear and right rear sides of the straddle type vehicle 4 are captured within the angle of view, the image captured by the in-vehicle camera 44 includes information unnecessary for the purpose of checking either the left rear or the right rear side. That is, at the time of the leftward course change, what the driver 2 mainly needs to check is a vehicle existing on the left rear side of the straddle type vehicle 4, and thus, it is less necessary to present information on the subject on the right rear side. From another viewpoint, presenting the information on the subject at the right rear side may cause the driver 2 to misunderstand the situation on the rear side, and thus it is not preferable to present the information as the rear image 402.

Therefore, the rear image 402 is generated by extracting, from the image captured by the in-vehicle camera, an image of a region corresponding to the course change direction. More specifically, at the time of the leftward course change guidance, as illustrated in FIG. 5B, the control unit 31 generates the rear image 402 by extracting a region capturing the left rear subject, including the direct rear of the straddle type vehicle 4, in the image captured by the in-vehicle camera 44. In addition, at the time of the rightward course change guidance, as illustrated in FIG. 5C, the control unit 31 generates the rear image 402 by extracting a region capturing the right rear subject, including the direct rear of the straddle type vehicle 4, in the image captured by the in-vehicle camera 44.

Incidentally, a rear position where the driver 2 needs to check a situation differs according to a distance to a course change point at which the course change is to be completed. That is, at the time of notification of an advance notice of the course change, it is preferable to be able to broadly check the rear side on the course change destination side, where there is a sufficient distance to the course change point and vehicles that may require attention at the time of a subsequent course change are distributed. For example, since there is a possibility that a following vehicle immediately behind makes a lane change to the course change destination side, it is preferable to be able to check a situation including not only the rear side of the course change destination side but also the direct rear thereof. On the other hand, at the time of notifying a timing at which the driver 2 needs to actually make a lane change, when the distance to the course change point is short, it is preferable to be able to particularly check a region closer to the straddle type vehicle 4, where vehicles having a high possibility of entering the course change destination are distributed. That is, at the timing when the course change is actually made, the vehicle traveling far behind the straddle type vehicle 4 is less likely to come in contact with the straddle type vehicle 4, and it is less necessary to notify the driver 2. For example, in the case of the leftward course change, there is a possibility of interfering with the vehicle traveling in the immediate vicinity in the left lane, and thus it is highly convenient to enable the driver 2 to check the situation in the rear image 402 before moving their gaze to a side mirror.

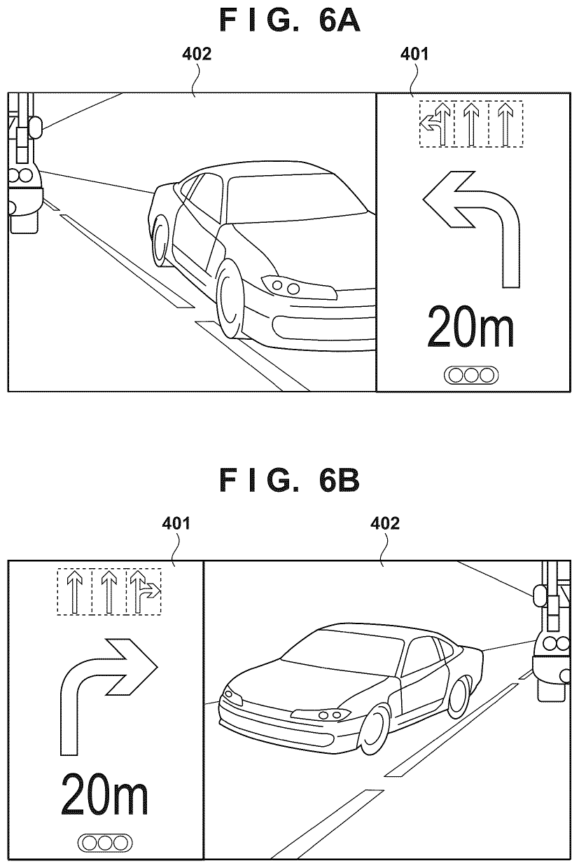

Therefore, in generating the rear image 402, the region to be extracted from the captured image of the in-vehicle camera 44 is varied according to the distance to the course change point. More specifically, in the mode in which the image captured by the in-vehicle camera 44 is FIG. 5A, for example, in a case where the distance to the course change point exceeds a predetermined threshold, the rear image 402 is generated by extracting the entire region close to the course change destination side as illustrated in FIGS. 5B and 5C. On the other hand, for example, in a case where the distance to the course change point falls below the threshold value, the rear image 402 is generated by extracting a region near the straddle type vehicle 4 out of the region close to the course change destination side as illustrated in FIG. 6. Here, the region near the straddle type vehicle 4 refers to a region, such as a side of the straddle type vehicle 4, in which a subject within a predetermined distance from the straddle type vehicle 4 is captured. FIG. 6A illustrates a guidance screen displayed at a timing at which the leftward course change is to be made, and FIG. 6B illustrates a guidance screen displayed at a timing at which the rightward course change is to be made. As can be seen by comparing FIGS. 4A and 4B with FIGS. 6A and 6B, the rear image 402 of the guidance screen displayed when the distance to the course change point falls below the threshold is configured to present the rear situation more limitedly to the driver 2 as compared with the case where the distance exceeds the threshold.

In the present embodiment, a description is given assuming that the region from which the rear image 402 is extracted is controlled to differ depending on whether or not the distance to the course change point exceeds the threshold as described above. More specifically, in a case where the distance to the course change point exceeds the threshold, an image obtained by extracting the entire region close to the course change destination side is used as the rear image 402, and in a case where the distance is not more than the threshold, an image obtained by extracting a narrower region close to the straddle type vehicle 4 is used as the rear image 402. However, the implementation of the present invention is not limited to this, and for example, as the distance to the course change point becomes shorter, the extracted region may be controlled to be narrower so as to focus on a subject closer to the straddle type vehicle 4.

### Display Control Processing

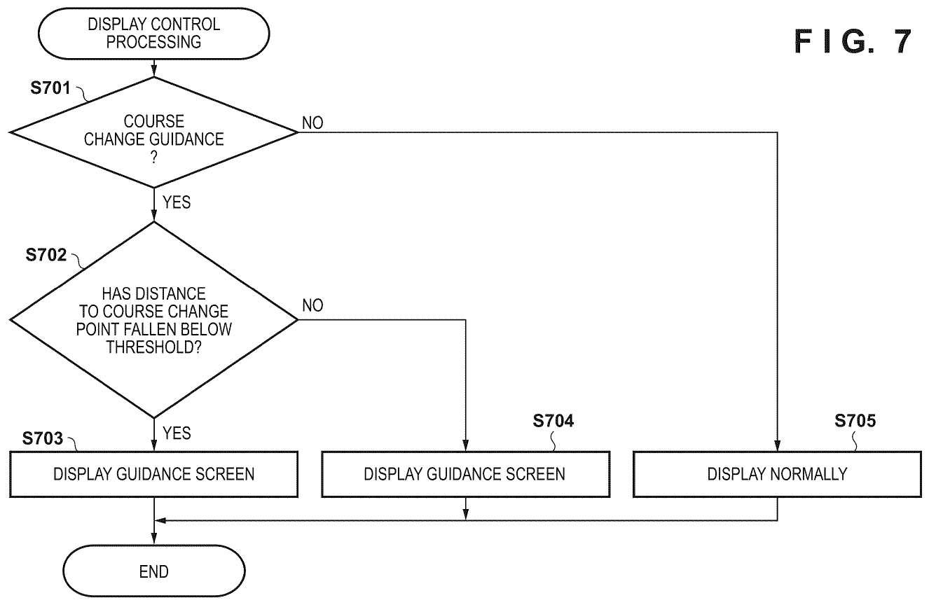

Hereinafter, specific processing of the display control processing related to the route guidance in the route guidance application in the portable communication terminal 3 of the present embodiment will be described with reference to a flowchart of FIG. 7. The processing corresponding to the flowchart can be implemented by the control unit 31, for example, reading a corresponding processing program recorded in the ROM, developing the processing program in the RAM, and executing the processing program.

In step S701, the control unit 31 determines whether or not to provide course change guidance. Specifically, the control unit 31 determines whether or not the straddle type vehicle 4 approaches the next course change point in the movement of the route specified in the route guidance information and whether or not a distance to the point falls below a predetermined distance threshold. That is, the control unit 31 makes the determination in this step by acquiring information on the current location of the straddle type vehicle 4 (portable communication terminal 3), deriving the distance to the next course change point, and comparing the distance with the distance threshold. The distance threshold used for the determination in this step is set to a distance with a margin to the course change point, such as 600 m. In a case where the control unit 31 determines to provide the course change guidance, the control unit 31 proceeds to S702, and in a case where the control unit 31 determines not to provide the course change guidance, the control unit 31 proceeds to S705.

In S702, the control unit 31 determines whether or not the distance to the course change point has fallen below a threshold indicating a distance at which a course change is to be actually made. The threshold used for the determination in this step is set to a distance at which a course change operation is to be actually started, such as 20 m. In a case where the control unit 31 determines that the distance to the course change point has fallen below the threshold, the control unit 31 proceeds to S703, and in a case where the control unit determines that the distance is greater than or equal to the threshold, the control unit 31 proceeds to S704.

In S703, the control unit 31 generates a guidance screen and causes the display unit 34 to display the guidance screen. More specifically, the control unit 31 extracts an image of the immediate region closer to the course change destination side from the captured image of the in-vehicle camera 44 received from the straddle type vehicle 4 to generate the rear image. Then, the control unit 31 generates a guidance screen on which the rear image and the direction indication image are arranged side by side in the horizontal direction, and displays the guidance screen on the display unit 34. For example, when making a left turn, the control unit 31 extracts, as the rear image, an image of a region where a left rear subject near the straddle type vehicle 4 as illustrated in FIG. 6B is captured.

On the other hand, in a case where it is determined in S702 that the distance to the course change point is greater than or equal to the threshold, in S704, the control unit 31 generates a guidance screen and causes the display unit 34 to display the guidance screen. More specifically, the control unit 31 extracts an image of the immediate region closer to the course change destination side from the captured image of the in-vehicle camera 44 received from the straddle type vehicle 4 to generate the rear image. Then, the control unit 31 generates a guidance screen on which the rear image and the direction indication image are arranged side by side in the horizontal direction, and displays the guidance screen on the display unit 34. For example, when making a left turn, the control unit 31 extracts, as the rear image, an image of a region including the left rear side and the direct rear of the straddle type vehicle 4 as illustrated in FIG. 4A.

In a case where it is determined in S701 that course change guidance is not provided, in S705, the control unit 31 performs display related to normal route guidance. The display may be, for example, a display in which information on a route and a current location is superimposed on map information, or a display in which a captured image of the in-vehicle camera 44 that is not extracted is displayed.

With this configuration, according to the route guiding device of the present embodiment, it is possible to assist the driver in checking the rear side at the time of course changes, and thus contribute to improvement of safety in vehicle driving. More specifically, the driver checks the display at the time of the course change guidance, so that the driver can grasp a direction in which the course is to be changed and a situation behind the vehicle without moving their gaze. In addition, since the region extracted from the image captured by the in-vehicle camera 44 changes according to the direction of the course change, and the image of the region is arranged and displayed on the course change destination side, it is possible to allow the driver to intuitively grasp the situation of the rear side on the course change destination side. In addition, since the extracted region changes according to the distance to the course change point, it is possible to notify the driver of the subject that is to be appropriately paid attention to at each stage, from when the driver is made aware of the course change until the course change is actually made.

### First Modification

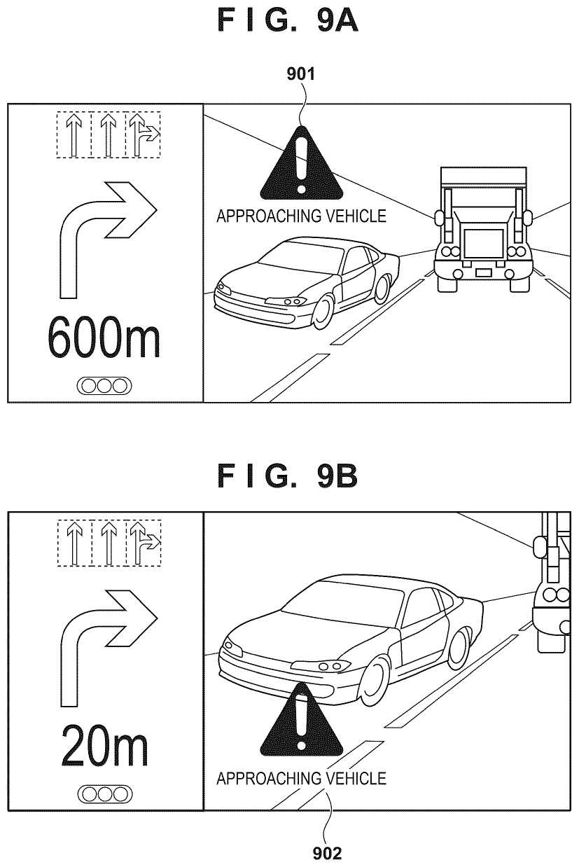

In the embodiment described above, the description is given assuming that the guidance screen including the direction indication image and the rear image is displayed on the display unit 34 in a case where the course change guidance is provided. On the other hand, the perception of the inter-vehicle distance from the vehicle traveling behind may be different between a case where the driver visually checks the rear image of the guidance screen and a case where the driver visually checks the rear side. For this reason, the distance to the straddle type vehicle 4 may be derived for each object such as a vehicle or a person captured within the angle of view on the basis of the captured image, and in a case where there is an object approaching within a predetermined distance, a warning to that fact may be issued on the guidance screen. For example, as illustrated in FIGS. 9A and 9B, the warning on the guidance screen can be performed by superimposing a warning display 901 or 902 on a position corresponding to the object in the rear image. As illustrated in the drawing, such a warning regarding the object approach may be configured to be issued regardless of the distance to the course change point. In addition, the predetermined distance serving as a criterion for determining whether or not to issue a warning may be set to a fixed value such as 20 m, or may be set to a value that varies according to the vehicle speed of the straddle type vehicle 4 (the distance becomes longer when the vehicle speed is high, and shorter when the vehicle speed is low).

### Second Embodiment

In the embodiment described above, a mode has been described in which the route planning server 5 generates route guidance information on the basis of information on a departure point and a destination, and the portable communication terminal 3 receives the route guidance information and provides route guidance, but the implementation of the present invention is not limited thereto. The generation of the route guidance information from the departure point to the destination may be performed by the control unit 31 in the portable communication terminal 3 using the road information stored in advance in the storage unit 32. That is, the present invention can also be implemented by the portable communication terminal 3 which acquires the captured image of the in-vehicle camera 44 without being connected in a communication-enabling manner to the route planning server 5.

### Third Embodiment

In the embodiment described above, the description is given assuming that the portable communication terminal 3 connected to the in-vehicle device 40 of the straddle type vehicle 4 performs the display control processing, but the implementation of the present invention is not limited thereto. The present invention may be implemented by executing the display control processing in the in-vehicle device 40 included in the straddle type vehicle 4 and displaying the guidance screen using a display device (display) such as a meter panel or a route guidance display provided in the straddle type vehicle 4.

### Configuration Example of In-Vehicle Device 40

FIG. 3B is a block diagram of the in-vehicle device 40 according to the present embodiment. In addition to the control unit 41, the storage unit 42, the communication unit 43, and the in-vehicle camera 44 described in the first embodiment, the in-vehicle device 40 includes a display unit 45 and a GNSS sensor 46 used for various displays including the course change guidance. The display unit 45 is an electronic image display device (display) having an input function, and is, for example, a touch panel display. The GNSS sensor 46 is a sensor which detects a current position of the straddle type vehicle 4. In addition, in the present embodiment, the communication unit 43 is a wireless communication device capable of communicating with the route planning server 5.

In the mode in which the in-vehicle device 40 is configured as described above, the control unit 41 may perform the display control processing described in the first embodiment and perform display control of the guidance screen on the display unit 45. That is, prior to the display control processing, the control unit 41 transmits information on the departure point and the destination to the route planning server 5 to acquire route guidance information, and provides route guidance on the basis of the route guidance information and the current location of the straddle type vehicle 4. The control unit 41 performs display of the guidance screen on the display unit 45 at the time of course changes, or performs normal route guidance display or display of a captured image of the in-vehicle camera 44.

Note that in the present embodiment, the description is given assuming that the in-vehicle device 40 of the straddle type vehicle 4 receives the route guidance information generated in the route planning server 5 and performs the route guidance, but the generation of the route guidance information may be performed in the in-vehicle device 40 as in a second embodiment. Alternatively, the route guidance information may be received from the portable communication terminal 3.

### Second Modification

In the embodiment described above, the description is given assuming that the direction indication image and the rear image are arranged side by side in the horizontal direction on the guidance screen displayed to guide the course change, but the implementation of the present invention is not limited thereto.

From a viewpoint of assisting the driver 2 in checking the rear side at the time of guiding the course change, the direction indication image and the rear image may be presented on the same screen, and the arrangement of these images on the guidance screen may adopt another mode such as being arranged in a vertical direction, for example.

### Third Modification

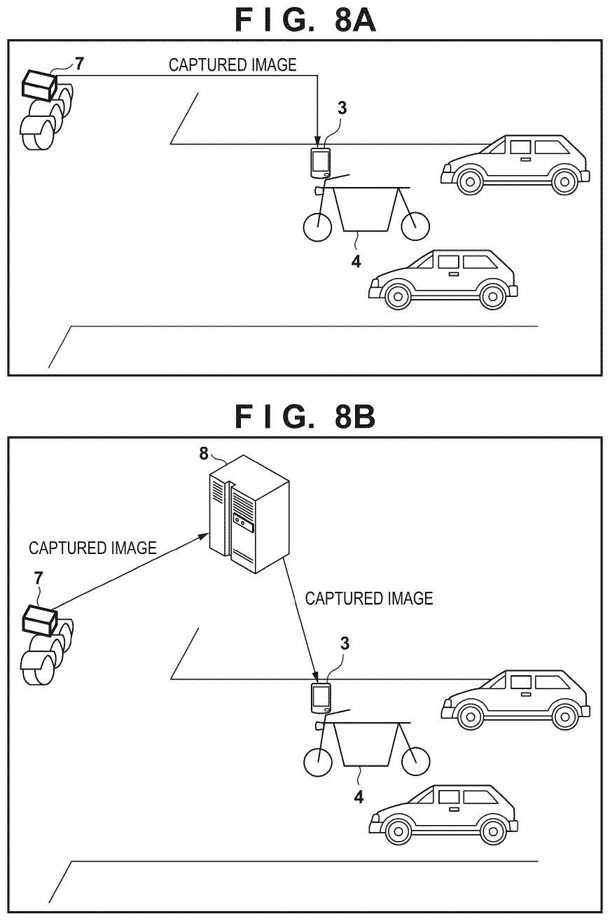

In the embodiment described above, the description is given assuming that the image used for the rear image is captured by the in-vehicle camera 44 provided in the straddle type vehicle 4, but the implementation of the present invention is not limited thereto. An image captured by a camera other than the in-vehicle camera 44 can also be used as the rear image as long as the image indicates at least the situation behind the straddle type vehicle 4. Such a camera includes, for example, a roadside camera installed on a traffic light, a pedestrian bridge, or the like. The in-vehicle device 40 included in the portable communication terminal 3 or the straddle type vehicle 4 can receive an image captured by a roadside camera arranged in an area where the straddle type vehicle 4 is present and use the image for display control processing, for example, when the vehicle approaches the course change point. The image is an image obtained by capturing a region including the rear side of the straddle type vehicle 4, and in the display control processing, an image of the region is extracted from the peripheral image and included as the rear image in the guidance screen to be displayed, so that the situation on the rear side at the time of course changes can be presented to the driver 2. In the acquisition of the image captured by the roadside camera 7, the image may be received by direct communication connection between the roadside camera and the portable communication terminal 3 or the straddle type vehicle 4 as illustrated in FIG. 8A, or may be received indirectly by communication connection with an external device 8 which sequentially records images captured by the roadside camera as illustrated in FIG. 8B.

### Fourth Embodiment

In the embodiment and the modification described above, the description is given assuming that the portable communication terminal 3 or the in-vehicle device 40 executes the display control processing. However, the display control processing may be executed, for example, in an arbitrary information communication terminal configured to be able to receive guidance execution of a course change as a trigger and receive a direction indication image and a peripheral image corresponding to the course change. In this case, a CPU (not illustrated) incorporated in the information communication terminal develops a program of display control processing recorded in a storage device such as an HDD into a RAM or the like, thereby executing selection processing. Here, the program of the selection processing executed by the CPU may be installed in a storage device of the information communication terminal via a storage medium such as a CD-ROM.

Although the present invention has been described in a plurality of embodiments and modifications, the configurations of these embodiments and modifications may be applied in combination.

### Summary of Embodiments

The above embodiments disclose at least the following route guiding device, route guiding method, storage medium, program, and straddle type vehicle.
1. A route guiding device (3, 40) of the above embodiments, comprises:
   image acquisition means (33, 43) for acquiring a peripheral image of a vehicle including at least a rear side of the vehicle; and
   display control means (31, 41) for displaying, when guiding a course change of the vehicle, a direction indication image (401) for the course change and the peripheral image side by side on a display (34, 45).

According to this embodiment, at the time of the course change guidance, the driver can grasp the situation behind the vehicle using only the display without moving their gaze.
2. In the route guiding device of the above embodiments,
   the display control means changes arrangement of the direction indication image and the peripheral image according to a direction of the course change.

According to this embodiment, it is possible to instantaneously grasp the direction of the course change.
3. In the route guiding device of the above embodiments,
   the display control means displays the direction indication image and the peripheral image on the display side by side in a horizontal direction, and
   the peripheral image is displayed to be arranged on a destination side of the course change on the display.

According to this embodiment, it is possible to allow the driver to intuitively grasp the situation of the rear side on the course change destination side.
4. In the route guiding device of the above embodiments,
   the display control means extracts, from the peripheral image, a region in which subjects on a destination side of the course change are distributed and displays the region on the display.

According to this embodiment, it is possible to present a subject to which the driver is to pay attention in a limited manner.
5. In the route guiding device of the above embodiments,
   guidance of the course change is started before the vehicle reaches a course change point, and
   the display control means varies a region to be extracted from the peripheral image, according to a distance between the course change point and the vehicle.

According to this embodiment, it is possible to notify the driver of a subject that is to be paid attention to, in a stepwise manner from when the driver is made aware of the course change until the course change is actually made.
6. In the route guiding device of the above embodiments,
   the display control means narrows the region to be extracted from the peripheral image in a case where the distance between the course change point and the vehicle is shorter than a threshold.

According to this embodiment, information that needs to be checked can be effectively conveyed to the driver.
7. In the route guiding device of the above embodiments,
   the display control means extracts a region close to the vehicle in the peripheral image and displays the region on the display in a case where the distance between the course change point and the vehicle is shorter than a threshold.

According to this embodiment, information that needs to be checked can be effectively conveyed to the driver.
8. The route guiding device of the above embodiments further comprises:
   information acquisition means for acquiring route guidance information, wherein
   the display control means determines whether or not to guide the course change on a basis of the route guidance information.

According to this embodiment, the course change can be guided at an appropriate timing during the route guidance.
9. The route guiding device of the above embodiments further comprises:
   communication means for communicating with an external device, wherein
   the information acquisition means acquires the route guidance information received in response to the communication means transmitting, to the external device, at least a departure point and a destination of the vehicle.

According to this embodiment, it is possible to present information that enables efficient rearward checking at the time of course changes by using route guidance information planned by an external device.
10. The route guiding device of the above embodiments further comprises:
   generation means for determining a route of the vehicle on a basis of at least a departure point and a destination of the vehicle and generating the route guidance information, wherein
   the information acquisition means acquires the route guidance information generated by the generation means.

According to this embodiment, it is possible to present information that enables efficient rearward checking at the time of course changes, on the basis of the determined route plan.
11. In the route guiding device of the above embodiments,
   the peripheral image is an image captured by an in-vehicle camera mounted on the vehicle.

According to this embodiment, it is possible to appropriately notify the driver of the situation behind the vehicle.
12. The route guiding device of the above embodiments further comprises:
   communication means for communicating with an external device, wherein
   the peripheral image is an image captured by a roadside camera, and
   the image acquisition means acquires an image received by the communication means from the roadside camera arranged in an area where the vehicle is present.

According to this embodiment, it is possible to appropriately notify the driver in a mode of overlooking the rear side of the vehicle.
13. A route guiding method, performed by a route guiding device, of the above embodiments comprises:
   an image acquisition step of acquiring a peripheral image of a vehicle including at least a rear side of the vehicle; and
   a display control step of displaying, when guiding a course change of the vehicle, a direction indication image for the course change and the peripheral image side by side on a display.

According to this embodiment, at the time of the course change guidance, the driver can grasp the situation behind the vehicle using only the display without moving their gaze.
14. A computer-readable storage medium of the above embodiments which has stored thereon a program for causing a computer to execute:
   image acquisition processing of acquiring a peripheral image of a vehicle including at least a rear side of the vehicle; and
   display control processing of displaying, when guiding a course change of the vehicle, a direction indication image for the course change and the peripheral image side by side on a display.

According to this embodiment, at the time of the course change guidance, the driver can grasp the situation behind the vehicle using only the display without moving their gaze.
15. A program of the above embodiments for causing a computer to execute:
   image acquisition processing of acquiring a peripheral image of a vehicle including at least a rear side of the vehicle; and
   display control processing of displaying, when guiding a course change of the vehicle, a direction indication image for the course change and the peripheral image side by side on a display.

According to this embodiment, at the time of the course change guidance, the driver can grasp the situation behind the vehicle using only the display without moving their gaze.
16. A straddle type vehicle of the above embodiments comprises: a display; a camera; and a control device, wherein
   the control device includes
      image acquisition means for acquiring a peripheral image of the straddle type vehicle, including at least a rear side of the straddle type vehicle, captured by the camera, and
      display control means for displaying, when guiding a course change of the straddle type vehicle, a direction indication image for the course change and the peripheral image side by side on the display.

According to this embodiment, at the time of the course change guidance, the driver can grasp the situation behind the vehicle using only the display without moving their gaze.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A route guiding device which provides route guidance based on route guidance information, comprising:
an image acquisition unit configured to acquire a peripheral image of a vehicle including at least a rear side of the vehicle; and
a display control unit configured to display, when guiding a course change of the vehicle before the vehicle reaches a course change point, a direction indication image for the course change and the peripheral image side by side on a display, wherein
the display control unit changes arrangement of the direction indication image and the peripheral image according to a direction of the course change, and
the peripheral image is arranged on a destination side of the course change on the display, wherein
the route guiding device further comprises a deriving unit configured to derive, based on the peripheral image, a distance between the vehicle and peripheral objects of the vehicle, wherein
the display control unit extracts, from the peripheral image, a region in which subjects on a destination side of the course change according to a distance between the course change point and the vehicle, and displays the region on the display,
in a case where there is a peripheral object approaching within a predetermined distance, the display control unit displays a warning on the display by superimposing the warning at a position corresponding to the peripheral object on the peripheral image, and
the region to be extracted from the peripheral image is set to a region closer to the vehicle in a case where the distance between the course change point and the vehicle falls below a threshold than in a case where the distance exceeds the threshold.

2. The route guiding device according to claim 1, wherein
the display control unit varies a region to be extracted from the peripheral image, according to a distance between the course change point and the vehicle.

3. The route guiding device according to claim 2, wherein
the region to be extracted from the peripheral image is set to a narrower region in a case where the distance between the course change point and the vehicle falls below the threshold than in a case where the distance exceeds the threshold.

4. The route guiding device according to claim 1, further comprising:
an information acquisition unit configured to acquire the route guidance information.

5. The route guiding device according to claim 4, further comprising:
a communication unit configured to communicate with an external device, wherein
the information acquisition unit acquires the route guidance information received in response to the communication unit transmitting, to the external device, at least a departure point and a destination of the vehicle.

6. The route guiding device according to claim 4, further comprising:
a generation unit configured to determine a route of the vehicle on a basis of at least a departure point and a destination of the vehicle and generating the route guidance information, wherein
the information acquisition unit acquires the route guidance information generated by the generation unit.

7. The route guiding device according to claim 1, wherein
the peripheral image is an image captured by an in-vehicle camera mounted on the vehicle.

8. The route guiding device according to claim 1, further comprising:
a communication unit configured to communicate with an external device, wherein
the peripheral image is an image captured by a roadside camera, and
the image acquisition unit acquires an image received by the communication unit from the roadside camera arranged in an area where the vehicle is present.

9. A route guiding method performed by a route guiding device which provides route guidance based on route guidance information, comprising:
an image acquisition step of acquiring a peripheral image of a vehicle including at least a rear side of the vehicle; and
a display control step of displaying, when guiding a course change of the vehicle before the vehicle reaches a course change point, a direction indication image for the course change and the peripheral image side by side on a display, wherein
in the display control step, arrangement of the direction indication image and the peripheral image is changed according to a direction of the course change, and
the peripheral image is arranged on a destination side of the course change on the display, wherein
the route guiding method further comprises a deriving step of deriving based on the peripheral image, a distance between the vehicle and peripheral objects of the vehicle, wherein
in the display control step:
a region in which subjects on a destination side of the course change is extracted from the peripheral image according to a distance between the course change point and the vehicle, and is displayed on the display, and
in a case where there is a peripheral object approaching within a predetermined distance, a warning is displayed on the display by superimposing the warning at a position corresponding to the peripheral object on the peripheral image, and
the region to be extracted from the peripheral image is set to a region closer to the vehicle in a case where the distance between the course change point and the vehicle falls below a threshold than in a case where the distance exceeds the threshold.

10. A straddle type vehicle comprising a display a camera and a control device and providing route guidance based on route guidance information, wherein
the control device includes
an image acquisition unit configured to acquire a peripheral image of the straddle type vehicle, including at least a rear side of the straddle type vehicle, captured by the camera, and
a display control unit configured to display, when guiding a course change of the straddle type vehicle before the straddle type vehicle reaches a course change point, a direction indication image for the course change and the peripheral image side by side on the display, wherein
the display control unit changes arrangement of the direction indication image and the peripheral image according to a direction of the course change, and
the peripheral image is arranged on a destination side of the course change on the display, wherein
the control device further comprises a deriving unit configured to derive, based on the peripheral image, a distance between the straddle type vehicle and peripheral objects of the straddle type vehicle, wherein
the display control unit extracts, from the peripheral image, a region in which subjects on a destination side of the course change according to a distance between the course change point and the straddle type vehicle, and displays the region on the display,
in a case where there is a peripheral object approaching within a predetermined distance, the display control unit displays a warning on the display by superimposing the warning at a position corresponding to the peripheral object on the peripheral image, and
the region to be extracted from the peripheral image is set to a region closer to the straddle type vehicle in a case where the distance between the course change point and the straddle type vehicle falls below a threshold than in a case where the distance exceeds the threshold.
